(19) United States
(12) Patent Application Publication
(10) Pub. No.: US 2004/0083261 A1
(43) Pub. Date: Apr. 29, 2004

(54) Multi-agent system design using role models

(76) Inventors: Simon G Thompson, Suffolk (GB); Anthony Karageorgos, Manchester (GB)

Correspondence Address: NIXON & VANDERHYE, PC, 1100 N GLEBE ROAD, 8TH FLOOR, ARLINGTON, VA, 22201-4714, US

(21) Appl. No.: 10/468,737

(22) PCT Filed: Mar. 8, 2002
(86) PCT No.: PCT/GB02/01048

(30) Foreign Application Priority Data
Mar. 16, 2001 (EP) 01302442.7

(51) Int. Cl. G06F 15/16; G06F 17/00; G06N 7/08; G06N 7/00

(52) U.S. Cl. 709/202; 706/59

(57) ABSTRACT

A computer-assisted method of designing a multi agent system (23) comprises storing predefined role models (21,22) within a library (20), selecting desired models from the library, and merging them into a single system model (23). Each model (21,22) has associated with it one or more compositional constraints (25,26), and these are automatically taken into consideration during role composition by a synthesis engine (24) during the merging process.

The present invention relates to multi-agent system design using role models. More specifically, although not exclusively, the invention relates to a computer-aided method of system design which is capable of making use of multiple pre-defined role models.

Multi-agent system architectures can be naturally viewed as organised societies of individual computational entities. Therefore, many authors argue that social and organisational abstractions should be considered as First Class design constructs. Furthermore, there is a consensus that there is no standard best organisation for all circumstances: criteria that could affect an organisational design decision are numerous and highly dependent on factors that may change dynamically. However, deciding on the way a particular set of agents will be organised is currently an issue that is ultimately left to the creativity and the intuition of the system designer. This can be a serious drawback when designing large and complex real-world agent organisations.

Many research prototypes of agent-based systems are built in an ad-hoc manner. However, the need to engineer agent systems solving real-world problems has given rise to a number of systematic methodologies for agent oriented analysis and design including the following:

Evans, R., MESSAGE: Methodology for Engineering Systems of Software Agents, 2000, BT Labs: Ipswich.

Inglesias, C. A., et al., Analysis & Design of Multi-Agent Systems using MAS-CommonKADS, in Intelligent Agents IV—Proceedings of the Fifth International Workshop on Agent Theories, Architectures & Languages (ATAL-97), M. P. Singh, A. S. Rao, & M. J. Wooldridge, Editors. 1998, Spriger-Verlag: Berlin. p. 313-326.

Omicini, A. SODA: Societies & Infrastructures in the Analysis & Design of Agent-based Systems. in Workshop on Agent-Oriented Software Engineering, 2000. Limerick, Ireland.

Wooldridge, M., N. R. Jennings, & D. Kinny, The Gaia methodology for agent-oriented analysis and design. International Journal of Autonomous Agents and Multi-Agent Systems, 2000. 3.

All these methodologies involve a number of analysis and design sub-models emphasising particular analysis and design aspects. Organisational settings may either be explicitly specified in an organisational model, or implicitly defined from the functionality that agents are assigned.

In all methodologies, organisational abstractions can be incorporated in the agent system either in a top-down or bottom-up fashion according to lessons learned from designing business organisations and distributed software systems, or according to the philosophical preference of the authors. Furthermore, organisation can take place either statically or dynamically. Static organisation is done once and for all on design time, while dynamic organisation is done as and when required on run-time.

Some approaches are particularly targeted on open agent systems, emphasising the need to reinforce general organisational rules and consider organisational abstractions as First Class design constructs. This application proceeds from the belief that ensuring appropriate organisational settings is the best and perhaps the only way to achieve smooth operation in open agent systems.

A very attractive notion for conceptual modelling of software systems is that of role. Roles are also used in organisational theory and business process modelling to represent positions and responsibilities in business organisations.

A major advantage of role-based modelling is the inherent ability to represent encapsulated functionality. Therefore, roles are particularly suitable for modelling OO (Object-Oriented) software systems. Role based modelling is mainly used in static agent organisation approaches. However, dynamic approaches can also be supported by including role migration and role evolution.

Roles can be used for the design of multi-agent systems: see for example the Omicini and Wooldridge et al papers mentioned above, as well as Kendall, E. A., Role models—patterns of agent system analysis & design, BT Technology Journal, 1999. 17(4): p. 46-57; and Zambonelli, F., N. R. Jennings, & M. Wooldridge: Organisational Abstractions for the Analysis and Design of Multi-Agent Systems, in Workshop on Agent-Oriented Software Engineering 2000 Limetick, Ireland.

Agent roles are here defined in a manner similar to organisational roles referring to a position and a set of responsibilities in an organisation. To better represent agent concepts, the agent role definition may include additional characteristics, for example planning, co-ordination and negotiation capabilities—see for example the Kendall paper mentioned above.

Roles can be extended to create specialised roles by a process called specialisation or refinement. Specialised roles represent additional behaviour on top of the original behaviour in a manner similar to inheritance in object oriented systems.

A collection of roles and their interactions is known as a role model. Role models represent the behaviour required to carry out some activity. An agent application normally consists of more than one activity (use cases) and hence it will involve more than one role model.

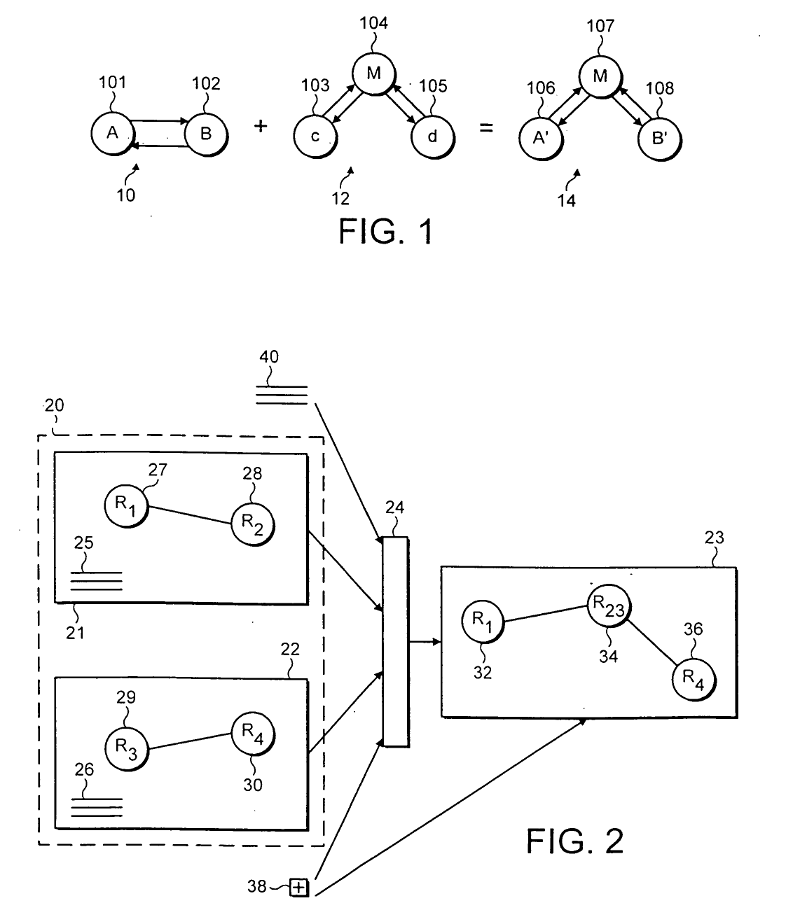

Role models can be visualised in terms of role diagrams. A role diagram (e.g. FIG. 1) is a collection of graphical primitives representing information about roles and their lines of interaction.

The process of merging a number of roles into a single composite role is called role composition. Role composition occurs when roles are allocated to agents. In role composition, roles may semantically constrain each other. For example two roles may exclude each other meaning that a single agent cannot play both roles at the same time. Furthermore, the way that role characteristics and their attributes are merged may be limited by various constraints. For example, the memory required by the composite role resulting from the merging of two roles may not be equal to the sum of the memories required by the two individual roles.

FIG. 1 illustrates the composition of two interrelated roles 101,102 (indicated generally by the numeral 10) with three further interrelated roles 103,104,105 (indicated generally by the numeral 12). The result, in this particular example, consists of three inter-linked agents 106,107,108 (together represented by the numeral 14).

According to a first aspect of the present invention there is provided a computer-assisted method of designing multi agent systems, comprising:

(a) defining a plurality of role models, some or all of the role models including:

(i) a plurality of roles;

(ii) a representation of role interactions; and

(iii) a representation of role compositional constraints applicable to the respective model;

(b) storing the role models in a library; and

(c) selecting from the library a plurality of role models for use in the design of a multi-agent system, and merging the selected role models into a single system model by applying role composition to the individual roles dependent upon the role compositional constraints applicable to each of the selected role models.

In another aspect there is provided a computer-assisted method of designing multi-agent systems, comprising:

(a) defining a plurality of role models, some or all of the role models including:

(i) a plurality of roles;

(ii) a representation of role interactions; and

(iii) a representation of role compositional constraints applicable to the respective model;

(b) storing the role models in a library for later selection and re-use as required for merging into a multi agent system being designed.

In another aspect, there is provided a computer-assisted method of designing multi-agent systems, comprising:

(a) selecting from a library a plurality of role models for use in the design of a multi-agent system, each role model including:

(i) a plurality of roles

(ii) a representation of role interactions; and

(iii) a representation of role compositional constraints applicable to the respective model; and

(b) merging the selected role models into a single system model by applying role composition to the individual roles dependent upon the role compositional constraints applicable to each of the selected role models.

In another aspect, there is provided a computer system for facilitating the design of multi agent systems, comprising:

(a) means for defining a plurality of role models, some or all of the role models including:

(i) a plurality of roles

(ii) a representation of role interactions; and

(iii) a representation of role compositional constraints applicable to the respective model;

(b) a library for storing the role models; and

(c) means for selecting from the library a plurality of role models for use in the design of a multi-agent system, and a synthesis engine for merging the selected role models into a single system model by applying role composition to the individual roles dependent upon the role compositional constraints applicable to each of the selected role models.

In another aspect, there is provided a computer system for facilitating the design of multi agent systems, comprising:

(a) means for defining a plurality of role models, some or all of the role models including:

(i) a plurality of roles

(ii) a representation of role interactions; and

(iii) a representation of role compositional constraints applicable to the respective model; and

(b) a library for storing the role models for later selection and re-use as required for merging into a multi agent system being designed.

In another aspect, there is provided a computer system for facilitating the design of multi agent systems, comprising:

(a) means for selecting from a library a plurality of role models for use in the design of a multi-agent system, each role model including:

(i) a plurality of roles

(ii) a representation of role interactions; and

(iii) a representation of role compositional constraints applicable to the respective model; and

(b) a synthesis engine for merging the selected role models into a single system model by applying role composition to the individual roles dependent upon the role compositional constraints applicable to each of the selected role models.

The invention further extends to a computer system for carrying out a method as described in the claims, or as mentioned above.

The invention further extends to a computer program for implementing any such method, as well as to a computer-readable carrier which actually carries the such program.

The present invention provides an improved and a more systematic way to construct large agent system design models, without having to rely entirely upon the creativity and the intuition of the designer. The invention provides that some of the knowledge of the designers of the underlying role models are immediately available to the later system designer, eg by means of a software tool.

The invention conveniently provides a means for designers to consider performance requirements at design time, thereby avoiding substantial runtime reorganisations for the sake of system stability.

The invention further provides for the capability of re-using organisational set-ups, settings and characteristics which have proved successful in the past. By classifying and noting known organisational patterns, and providing a means for selecting them in a particular design context, the present invention provides for previously-used organisational patterns to be reused, along with the knowledge contained within them, when implementing large scale real-world applications.

To facilitate automatic tool support for role-based agent system design, the present invention preferably makes use of a role algebra describing relations between roles and their characteristics. Knowledge may be captured and encoded (by the model builder when the role model is stored in the role library) in the form-of this role algebra. The agent system designer may identify role models and instantiate role interaction patterns as appropriate. Instantiation consists of specifying all role characteristics. Subsequently, roles are in the preferred embodiment of the invention allocated to agents, while observing any compositional and/or other constraints.

The invention may be carried into practice in a number of ways and one specific embodiment will now be described, with reference to the drawings, in which:

FIG. 1 shows the known process of role composition, previous described;

FIG. 2 shows the procedure for combining role models according to the preferred embodiment of the present invention;

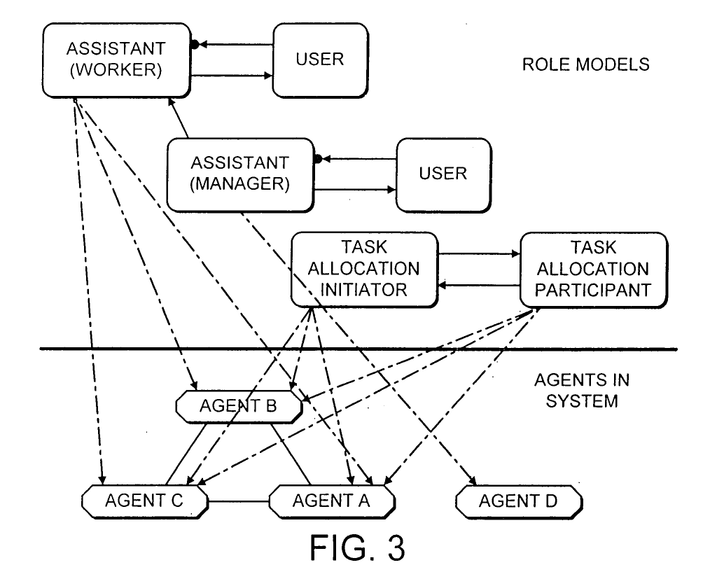

FIG. 3 shows a specific example in which the invention is applied to a particular problem, using direct interaction for task allocation; and

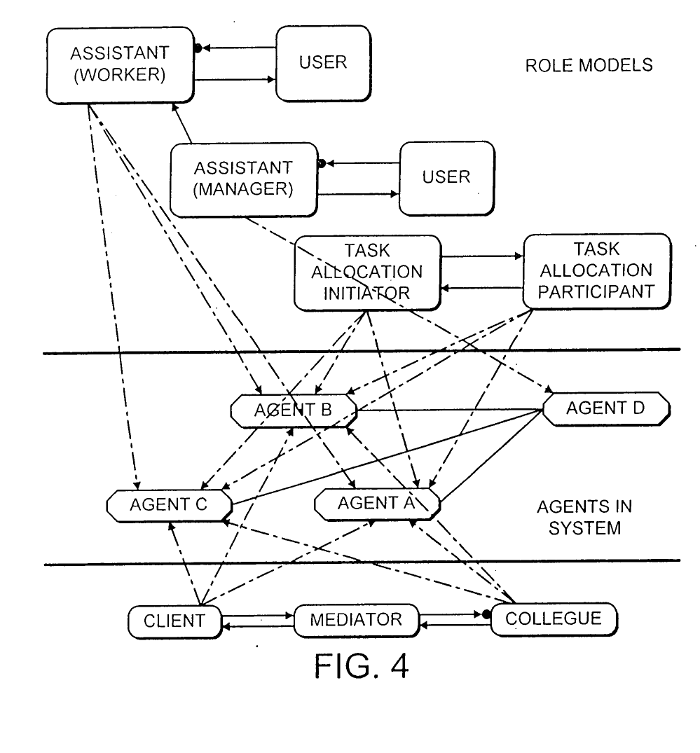

FIG. 4 corresponds to FIG. 3 except that the problem has been dealt with by making use of mediated interaction for task allocation.

Our view of roles is that they are representations of concrete behaviour. The expression ‘role’, as used in this application, refers not only to a position and a set of responsibilities in an organisation at a conceptual level, but also to the behaviour that is associated with that position at a pragmetic level. We define a role as the behaviour associated with a position and a set of characteristics within an application domain.

More specifically, a role is capable of carrying out certain tasks and can have various responsibilities or goals that it aims to achieve. Roles normally need to interact with other roles, which are known as their collaborators. Interaction takes place preferably by exchanging messages.

Role models that frequently occur in some application domain may be called role interaction patterns. Role interaction patterns can be used to represent recurring complex behaviour based on multiple points of interaction, and we therefore believe that they should sensibly be considered as First Class design constructs. Thus, interaction patterns can conveniently be used to describe various types of recurring behaviour, including organisational behaviour, application behaviour and computer system specific behaviour, e.g. an interface to legacy systems. We identify three types of role interaction patterns:

Application patterns: These describe behaviour specific to the application domain.

System/utility patterns: These describe behaviour concerning non-functional requirements of the application. For example, the behaviour that duplicates data storage aiming to increase system reliability can be described by a utility role interaction pattern.

Organisation patterns: These specify organisational abstractions that we would like to impose on the agent system. When organisational patterns are composed with application patterns, they modify the way that application functionality is realised. For example, applying a mediator organisational pattern differentiates the way interaction between application roles is done. In FIG. 1, roles A and B interact to realise some application functionality. Initially, the collaborators of A and B are B and A respectively. After merging the application pattern with the mediator pattern, roles A and B are transformed to A′ and B′ that interact only via role M. There are many other types of organisational patterns that could be used, including master-slave, peer-to-peer and co-worker to co-worker patterns.

All of the above types of role interaction patterns, and many other types of intrinsic or extrinsic characteristics of a multi agent system to be designed, may in the present invention be dealt with programmatically rather than relying upon the personal knowledge, skill or intuition of the system designer. This is achieved by allowing for the formal encoding of these interaction patterns or other characteristics as compositional constraints, associated with a particular role model. These compositional constraints may include, but are not restricted to, the types of constraints referred to above in the discussion of FIG. 1.

In this application the expression “compositional constraints” extends to any constraint or condition applicable to the composition of two or more roles into one or more merged role or agent, and/or to the resultant characteristics of the merged role(s) or agent(s) once the composition process has been completed. The compositional constraints may, as mentioned above, encode intrinsic characteristics of the application (for example that a supervisor role cannot be combined into the same agent as a worker role), as well as external characteristics (for example that the memory overhead required by a single agent which resulted in the combining of two roles may not be the same as the sum of the memories specified in each of those two roles).

The way in which the invention is preferably carried into practice will now be described in more detail, with reference initially to FIG. 2.

The system designer, in the example shown, wishing to construct a multi agent system, initially refers to a library (indicated by the dotted lines 20) of predefined role models, 21,22. In the Figure, only two role models are shown for the sake of simplicity, although in practice of course there could well be many more.

Each role model 21,22 within the library encapsulates a plurality of roles such as 27,28 or 29,30, as well as information on the respective role interactions within the role model, and a formal representation 25,26 of the role compositional constraints which are applicable to the respective model. Each role model may also encapsulate additional information, characteristics or parameters (not shown).

Once the designer has selected the role models that are to be used as the basis for the system to be built, he or she then merges those selected role models into a single system role model 23 by passing them through a synthesis engine 24. The synthesis engine takes the individual roles 27,28,29,30 from the selected role models 21,22 and applies predefined rules of role composition to them, while at the same time respecting the conditions set out in the compositional constraints 25,26. The result, in this particular example, is three roles/agents 32,34,36.

The designer has the option of manually controlling or influencing the process, as indicated by reference numeral 38, by manual or other external inputs either to the synthesis engine 24, or to the system model 23 itself. It should be understood that, typically, the system designer will still have an important part to play in generation of the final design, and it is accordingly expected that in most cases the present invention may more properly be categorised as “computer-assisted” design, rather than fully automated design.

The designer may also make use of general constraints 40, which are not associated with any particular role model. These will be described in more detail below.

The model 23 could, if desired, be stored back within the library 20, thereby making it available as a role model in its own right for possible selection at a later date by future designers who may wish to combine it with other role models. The stored version could be associated with (designer-created) additional constraints (not shown), as well as with the underlying constraints inherited from the role models it was composed from.

Typically, instantiation of the system model 23 will occur only once the model has been finalized, and saved by the designer in the preferred form. Alternatively, it would be possible for the system to be fully automated so that instantiation occurs automatically once the synthesis engine is provided with appropriate inputs. In that case, of course, reference numeral 23 represents the running system, with reference numerals 32,34 and 36 the corresponding agents within that system.

As above, any instantiation may have additional constraints associated with it, as well as the underlying constraints inherited from the role models it was composed from.

In order to provide a defined set of inputs to the synthesis engine 24, a protocol has to be devised for representing the compositional constraints 25,26 which are associated with each of the role models 20,22. In the preferred embodiment, we make use of a formal role algebra which describes relations between roles and their characteristics. This algebra makes use of the following seven algebraic relations. Let R be the set of roles in a role model. Then, for any r₁, r₂ ε R, one and only one of the following binary relationships may hold:

1. excludes—This means that r₁ and r₂ cannot be played by the same agent simultaneously. For example, in a conference reviewing agent system, an agent should not be playing the roles of paper author and paper reviewer at the same time. Any excludes relation E ⊂ R×R is symmetric:

if (r1 excludes r2) ε E then (r2 excludes r1) ε E

2. contains—This means that one role is a sub-case/specialisation of the other. Therefore, the behaviour it represents is completely included in the behaviour of the other role. For example, a role representing a manager behaviour completely contains the behaviour of the employee role. Any contains relation C ⊂ R is reflexive, transitive and anti-symmetric:

(r contains r) ε C, ∀ r ε R

if (r1 contains r2) ε C and (r2 contains r3) ε C then (r1 contains r3) ε C

if (r1 contains r2) ε C then (r2 contains r1) ∉ C

3. addswith—The addswith relation can be used to describe that the behaviours the two roles represent do not interfere in any way. Therefore, they can be played by the same agent without any problems. An addswith relation A ⊂ R×R must be symmetric:

if (r1 addswith r2) ε A then (r2 addswith r1) ε A

4. mergeswith—The mergeswith relation can be used to describe that the behaviours of two roles overlap to some extend. Although the two roles can be played by the same agent, the characteristics of the role resulting from their composition are not equal to the sum of the characteristics of the two individual roles. A mergeswith relation M ⊂ R×R must be symmetric:

if (r1 mergeswith r2) ε M then (r2 mergeswith r1) ε M

5. requires—The requires relation can be used to describe that when an agent plays some role it must play a number of other roles as well. This is particularly applicable in cases where agents need to conform to general rules or to play organisational roles. A requires relation P ⊂ R×R must be reflexive, and transitive:

(r requires r) ε P, ∀ r ε R

if (r1 requires r2) ε P and (r2 requires r3) ε P then (r1 requires r3) ε P

6. enables—The enables relation is mostly useful to manipulate organisational roles. When a role enables another role this means that the second role can actively participate in defining the agent behaviour while otherwise it wouldn't. An enables relation E ⊂ R×R is anti-symmetric:

if (r1 enables r2) ε E then (r2 enables r1) ∉ E

7. disables—The disables relation prevents a role from being played by an agent. This means that if two roles such that the first disables the second are allocated to the same agent, the second role will remain passive and the behaviour it represents will not be exercised by the agent. A disables relation D ⊂ R×R is anti-symmetric:

if (r1 disables r2) ε D then (r2 disables 1) ∉ D

In the preferred embodiment, the seven relations mentioned above are exhaustive of those that can be used to construct compositional constrains, but it will of course be understood that other embodiments might well use additional, or other, relations.

In the case of the mergeswith relation, some further specification of how the two behaviours could be merged needs to be made. Let C be the set of all possible role characteristics. For each characteristic x ε C, the respective x′ belonging to the composite role may for example be given by the formula x′=(r₁(x)+r₂(x)+c)·x where r₁(x) and r₂(x) are coefficients describing the percentage of the contribution of each role to the resulting characteristic of the composite role and c is a constant. We expect the value of these coefficients to be in most cases 0 or 1.

The compositional constraints for each role model are formally encoded by the role model devisor in a language we have devised known as RCL (Role Constraint Language). There are two types of expression in the current implementation of the RCL language, namely relations and characteristics.

Relations in RCL are of the form:

roleIdentifier1 roleRelation Type roleIdentifier2 {

newRoleIdentifier.characteristic = {characteristic Value1}
newRoleIdentifier.characteristic = {characteristic Value2}

}

Characteristics are of the form:

roleIdentifier.characteristic=value

There are seven role relations, corresponding to the seven algebraic relations mentioned above. Each role relation is described by its label, roles, constraints and mappings, where:

1. label is the name of the relation (contains, addswith, requires, enables, disables, mergeswith, excludes);

2. roles is the set of roles that this relation applies to;

3. constraints is the test that is applied to putative role to agent maps that decides if the map is in violation of this relation; and

4. mappings is the set of actions to apply to the behaviours and characteristics of an agent that has a role with this relation allocated to it.

(Both constraints and mappings may sometimes be empty).

A performance variable may be associated with a role characteristic to describe some part of it more fully (thereby constraining the problem more tightly). Performance variables are parameters whole value defines the run-time behaviour represented by a role. For example, role multiplicity or resource capacity can be performance variables. Different values of role multiplicity can be used to describe different types of dynamic behaviour. Having role multiplicity of three means that we initially need to design three agents playing that role with all the consequences in communication load and resource consumption that this brings. Performance variables may be used when defining compositional constraints.

Where a performance variable is used, it takes the form:

roleIdentifier.characteristic.performanceVar=value

It is the job of the synthesis engine (24 in FIG. 2) to transform the RCL it receives as input from the selected models into the final design, if necessary aided by manual input from the human operator. In the preferred embodiment, the synthesis engine 24 constructs from the inputs applied to it a constraint satisfaction problem which may then be solved by any appropriate conventional library function, such as for example that provided by the standard Open Source Java Constraint Library. We used version 2.01, beta, April 2000.

The transformation of the RCL to the ultimate design will now be described in more detail, with reference to the “main algorithm”, as follows:

Main Algorithm

1. Role characteristics are retrieved for all role models that will be used in the design. (RCL retrieved from role model 1,2, . . . , n) if userSpec !=null noDomains=userSpec

2. The RCL is transformed and satisfied:

2.1 The numbers of constraint problem variables is calculated considering role multiplicity (each role corresponds to a number of variables according to its multiplicity)

2.2 The relations are re-expressed as constraints that can be handled by the Constraint Satisfaction Algorithm. (See Using the RCL relations as tests below). These are used to test if a solution proposed by the algorithm satisfies the constraints on the role models

2.3 The number of “domains” of the constraint satisfaction problem is allocated. This corresponds to the number of agent types in the final design.

2.3.1 if noDomains !=0 domains=noDomains

2.3.2 else domains=1

2.4. An attempt to solve the constraint satisfaction problem is made by using the user specified algorithm, currently one of: backtracking, backmarking or forward chaining (see Search Algorithms, below)

2.5. If a solution has been found, roles are mapped to agent types according to the solution. Otherwise noDomains++

2.6 if userSpec!=null && if noDomains>userSpec raise error and halt.

2.7 else goto 2.3

3. Allocate behaviours to agents:

The constraints are satisfied. A map has been created which specifies which roles will be implemented by which agents. The role characteristics must be mapped to the agents. This is done using the RCL constrains as a program. (See Roles mapping to agents, below)

Using the RCL Relations as Tests

The RCL relations, discussed above, are transformed into tests that can be applied to a map of roles to agents to see if it is legal. RCL relation is (label, roles, constraints, mappings). The relations that we have developed are contains, addswith, requires, enables, disables, mergeswith and excludes. he constraints on the role to agent maps for these relations are described below:

r excludes r′: !∃ a|r εa \hat{ } r′ εa

no agent may exist that contains r and r′

r contains r′: ∀ a|r ε a [symbol] r′ εa

for all the agents that contain r they must also contain r′

r contains r′ \hat{ } r′ contains r″: ∀ a|r ε a [symbol] r′ εa \hat{ } r″ εa

for all the agents that contain r they must also contain r′ and r″

r addswith r′: (∃ a|r εa \hat{ } r′ εa) v (∃ a|r εa \hat{ } ∃ a′|r′ εa′)

there exists an agent such that r is in that agent and r′ is in that agent, or there exists an agent that contains r and there exists an agent that contains r′.

r mergeswith r′: ∀a|r εa [symbol] r requires r′ iff !(r excludes r′)

for all agents that contain r merges with r′ implies that r requires r′ if, and only if there is no relation r excludes r′

(Mergeswith is a soft constraint on the agent model. It contains rules that describe the value of the characteristics in the composite role, and specifies how behaviours should be allocated to agents, but also expresses a preference that roles be allocated to an agent).

r requires r′: ∀a|r εa [symbol] r′ εa

if r requires r′ then for all agents that contain r they must also contain r′

r disables r′

does not constrain the agent model it is used solely for the allocation of behaviour to the agent

r enables r′

does not constrain the agent model, used for allocation of behaviour to the agent

Allocation of Behaviours From Roles to Agents

The RCL is used as the basis for step 3 of the main algorithm to allocate behaviours from roles to agent specifications. Two information sources are used to do this:

1. the role->agent map developed by the constraint solving episode

2. the RCL specification.

The rules for mapping are as follows:

For each agent a′:

1. obtain a list rolesina′={r′,r″, . . . ,rn} of all the roles that map to the agent a′

2. ∀r′ εR iff r′ has_relation_with r″ \hat{ } !(r′ mergeswith r″) [symbol] r″ ε rolesWithRelationr′

3. if ∃rεrolesina′ \hat{ } r′ε rolesWithRelationr′ \hat{ } r excludes r′ raise exception and halt

4. ∀r′ εR iff r′ mergeswith r″ [symbol] r″ ε mergesetr′

5. ∀rε mergesetr′ apply all rules in r, remove r from mergsetr′

6. add behaviours from r to a′

7. ∀r′ εrolesWithRelationr′

7.1 if r contains r′ discard r′ (a′ will already have all behaviors from r′) remove r′ from rolesina and rolesWithRelationr′

7.2 if r addswith r′ add behaviours from r′ to a′ remove r′ from rolesina and rolesWithRelationr′

7.3 if r requires r′ add behaviours from r′ to a′ remove r′ from rolesina and rolesWithRelationr′

7.4 if r disables r′ remove all behaviours from r′ from a′

7.5 if r enables r′ add all behaviours from r′ to a

Search Algorithms

In backtracking we start assigning values to variables and check whether any of the constraints are violated. If this happens when we have assigned a value to a variable then we backtrack and we assign a different value to that particular variable. If we have tried all combinations and we found no solution then no solution exists. Backtracking is fairly inefficient since when assigning a particular value to a variable causes a problem, this problem will be repeated many times in many variable combinations. Therefore, other algorithms try to remove combinations of values from variable domains that cause problems. In this way the algorithms get more efficient.

In backmarking the idea is that if some incombatibilities between the values of some variables are found, these will be stored and remembered and will not be considered again in future algorithm steps. In this way the search space is reduced.

Forward checking tries to remove possible future conflicts. When a value is assigned to a variable, all values of remaining variables that would conflict with this particular value are eliminated. In this way we prevent future inconsistencies.

As mentioned above, the invention is not restricted in its application for use with compositional constraints which are limited to individual role models. As shown in FIG. 2, the system may also make use of external or other constraints 40, which may further optimise or constrain the role composition constraint problem. These general constraints can be used to specify general heuristics or rules of thumb in role composition. For example, high cohesion, low coupling or interdependency, and proximity (keep behaviour and information together) can be used as criteria for distributing functionality in software components. The system designer could also define the maximum number of roles that an agent could play, or an upper limit to the resource capacity that the roles an agent plays would require. The designer might use general constraints to indicate, for example, that roles requiring access to similar resources may be allocated to the same agent.

In summary, to design an agent or organisation, we need to:

1. Define, identify or select the role models.

2. Specify the role characteristics, for example performance variables that could affect role composition.

3. Specify role compositional constraints, using the role algebra defined above.

4. Specify any general constraints.

5. Merge the selected role models by applying role composition rules subject to the constraints specified, and solve the resultant constraint satisfaction problem.

6. Finally, allocate roles to agents.

Finally, a specific example of the operation of the preferred embodiment will now be described, in the context of a case study concerning telephone repair service teams. The aim in this case was to build an agent system which would assist field engineers to coordinate their work. One of the functions of this system was that the agent system should assist field engineers in task allocation. To state the problem simply: who should do what job?

Each field engineer as well as the team manager needs to be assigned with a software agent acting as personal assistant. For this purpose, we need an application role, the Personal Assistant (PA) role. The PA role is further specialised to the Manager's Personal Assistant (MPA) role to cover the needs of a team manager. The field engineers personal assistants must carry out the task allocation on their behalf and therefore we identify two further application roles, Task Allocation Initiator (TAI) and Task Allocation Participant (TAP). TAI and TAP interact with each other using some behavioural protocol, for example contracting, to allocate telephone repair tasks. This is specified by:

TAI.protocols={contracting}

TAP.protocols={contracting}

Let us assume that we have a customer service team consisting of three field engineers and one manager. Then the following multiplicity's can be specified:

PA.multiplicity=3

MPA.multiplicity=1

TAI.multiplicity=any

TAP.multiplicity=any

In this team only one person can be a manager. Hence:

PA excludes MPA

The agent associated with each field engineer must participate in task allocation.

PA requires TAI

PA requires TAP

There is no problem when PA, TAI and TAP are allocated to the same agent:

PA addswith TAI

PA addswith TAP

TAI addswith TAP

This results in an agent system with two agent types and four agents (see FIG. 3):

Agent Type 1: PA, TAI, TAP

Agent Type 2: PAM

But, for security or privacy reasons direct agent negotiation may not be desired. So, interactions of the field engineer personal assistant agents should be done via an intermediary. This can be specified by using the mediator pattern (see FIG. 4). The mediator pattern includes the Mediator, Client and Colleague roles. To specify mediated interaction, additional compositional constraints are required. The TAI and TAP roles are merged with the Client and Colleague roles. As a result, TAI interacts with TAP via the Mediator. This is specified in RCL as follows:

TAI merges with Client {

TAI_Client.Collaborators = {Mediator}
TAI_Client.Protocols = {MediatedContractNet}

}

TAP mergeswith Colleague {

TAP_Colleague.Collaborators = {Mediator}
TAP_Colleague.Protocols = {MediatedContractNet}

}

There is no problem when TAI and TAP are in the same agent with Colleague and Client respectively:

TAI addswith Client

TAP addswith Colleague

To ensure privacy, no field engineer personal assistant agent can be the mediator. This is specified by:

PA excludes Mediator

The new set of compositional constraints results in two agent types and four agents (see FIG. 4).

Agent type 1: PA, TAI, TAP, Client, Colleague

Agent type 2: PAM, Mediator

The current practical implementation of the present invention consists of a custom-extension to the Zeus Agent Development Toolkit, Version 1.04. This is a toolkit created and placed into the public domain by British Telecommunications plc. It is available from that Company. Further details may be found in Nwana, H. S., et al., Zeus: A toolkit for Building Distributed Multi-Agent Systems, Applied Artificial Intelligence Journal, 1999. 13(1): p. 187-203.

We modified the Zeus agent development process and the Zeus AgentGenerator tool to support role algebraic operations. The characteristics of a Zeus agent, for example its planning abilities, are now defined by the roles the agent plays. The modified Zeus Agent development process includes the following stages:

Role model specification. The role models that will be used are specified. This involves instantiation of reusable role interaction patterns and definition of role models specific to the application under development.

Role configuration. The characteristics of each role, for example the resources it requires and the tasks it is able to perform are specified. At this stage any performance parameters are also defined.

Task definition. Tasks are defined in detail. Tasks can be primitive, summary, rulebase or planscripts.

Role collaborators: The collaborators of each role are specified.

Role behavioural protocols: The protocols used by a role to interact with other roles are specified.

Role compositional constraints: The constraints that must be observed when a role is composed with other roles are specified. At this stage the performance parameters are assigned some value.

To provide support for the extended agent development process we modified the Project Manager (PM) and Code Generator (CG) AgentGenerator components. We constructed four new components: these were the Library Manager (LM), Role Constraint Editor (RCE), Role Configuration (RC) and Role Allocation (RA) components.

The Project Manager is the main component of the Agent Generator tool. We extended the PM component and the Zeus Frame based Language as required to include support for roles and role patterns.

LM is a component where role interaction patterns can be edited, automatically translated to some extension of the Zeus frame-based language and stored on disk. The LM component aims at providing assistance in reusing design settings.

RCE now supports RCL based on the role algebra we introduced. RCE provides a convenient user interface where designers can edit and manipulate various types of constraints in RCL. The role allocation component formulates and solves a constraint satisfaction problem based on compositional constraints.

The RC component was created to provide an interface for defining all characteristics of a role.

Finally, the CG component has been modified to generate Java code based on the definitions of the roles an agent plays.

It would be possible, although not yet implemented in the current version, to allow for role migration and role evolution.

The role algebra described could be used to dynamically allocate and de-allocate roles to agents on runtime.

By making use of the present invention, model designers are enabled to code their expertise into their models, and save these for re-use by later system designers.

1. A computer-assisted method of designing multi agent systems, comprising:
(a) defining a plurality of role models, some or all of the role models including:
(i) a plurality of roles;
(ii) a representation of role interactions; and
(iii) a representation of role compositional constraints applicable to the respective model;
(b) storing the role models in a library; and
(c) selecting from the library a plurality of role models for use in the design of a multi-agent system, and merging the selected role models into a single system model by applying role composition to the individual roles dependent upon the role compositional constraints applicable to each of the selected role models.

2. A computer-assisted method of designing multi-agent systems as claimed in claim 1 in which the system model is itself then stored in the library for later possible re-use as a role model.

3. A computer-assisted method of designing multi-agent systems, as claimed in claim 1 or claim 2 in which the role compositional constraints are representative of behaviour specific to a role model domain.

4. A computer-assisted method of designing multi-agent systems as claimed in any one of the preceding claims in which the role compositional constraints are representative of organisational patterns desired to be incorporated into the system model.

5. A computer-assisted method of designing multi-agent systems as claimed in any one of the preceding claims in which the role compositional constraints are representative of characteristics external to the system model such as, for example, computer data storage requirements.

6. A computer-assisted method of designing multi-agent systems as claimed in any one of the preceding claims including subsequently making a second selection from the library, re-using at least one of the previously-selected role models, as the basis of another, different, system model.

7. A computer-assisted method of designing multi-agent systems as claimed in any one of the preceding claims in which the role compositional constraints are defined using a syntax enabling required or prohibited relationships between roles to be expressed.

8. A computer-assisted method of designing multi-agent systems as claimed in any one of the preceding claims in which the compositional constraints are defined using a syntax enabling preferred or not preferred relationships between roles to be expressed.

9. A computer-assisted method of designing multi-agent systems as claimed in any one of the preceding claims in which the applied role composition is further dependent upon general compositional constraints, not associated with a single specific role model.

10. A computer-assisted method of designing multi-agent systems as claimed in claim 9 in which the general compositional constraints are representative of a role allocation heuristic.

11. A computer-assisted method of designing multi-agent systems as claimed in claims 1 to 10 in which the role compositional constraints are representative of organisational patterns desired to be incorporated into the system model.

12. A computer-assisted method of designing multi-agent systems as claimed in claims 1 to 11 in which the role compositional constraints are representative of characteristics external to the system model such as, for example, computer data storage requirements.

13. A computer-assisted method of designing multi-agent systems, comprising:
(a) defining a plurality of role models, some or all of the role models including:
(i) a plurality of roles;
(ii) a representation of role interactions; and
(iii) a representation of role compositional constraints applicable to the respective model;
(b) storing the role models in a library for later selection and re-use as required for merging into a multi agent system being designed.

14. A computer-assisted method of designing multi-agent systems, comprising:
(a) selecting from a library a plurality of role models for use in the design of a multi-agent system, each role model including:
(i) a plurality of roles
(ii) a representation of role interactions; and
(iii) a representation of role compositional constraints applicable to the respective model; and
(b) merging the selected role models into a single system model by applying role composition to the individual roles dependent upon the role compositional constraints applicable to each of the selected role models.

15. A computer system for facilitating the design of multi agent systems, comprising:
(a) means for defining a plurality of role models, some or all of the role models including:
(i) a plurality of roles
(ii) a representation of role interactions; and
(iii) a representation of role compositional constraints applicable to the respective model;
(b) a library for storing the role models; and
(c) means for selecting from the library a plurality of role models for use in the design of a multi-agent system, and a synthesis engine for merging the selected role models into a single system model by applying role composition to the individual roles dependent upon the role compositional constraints applicable to each of the selected role models.

16. A computer system for facilitating the design of multi agent systems, comprising:
(a) means for defining a plurality of role models, some or all of the role models including:
(i) a plurality of roles
(ii) a representation of role interactions; and
(iii) a representation of role compositional constraints applicable to the respective model; and
(b) a library for storing the role models for later selection and re-use as required for merging into a multi agent system being designed.

17. A computer system for facilitating the design of multi agent systems, comprising:
(a) means for selecting from a library a plurality of role models for use in the design of a multi-agent system, each role model including:
(i) a plurality of roles
(ii) a representation of role interactions; and
(iii) a representation of role compositional constraints applicable to the respective model; and
(b) a synthesis engine for merging the selected role models into a single system model by applying role composition to the individual roles dependent upon the role compositional constraints applicable to each of the selected role models.

18. A computer program for carrying out a method as claimed in any one of claims 1 to 13.

19. A computer-readable carrier carrying a computer program as claimed in claim 18.
